(19) United States
(12) Patent Application Publication
(10) Pub. No.: US 2015/0266565 A1
(43) Pub. Date: Sep. 24, 2015

(54) OPTIMIZING GROUND MOVEMENT IN A WIDE-BODY AIRCRAFT EQUIPPED WITH NON-ENGINE DRIVE MEANS

(71) Applicants: Joseph J. Cox, Modiin (IL); Isaiah W. Cox, London (GB); Jan Vana, Prague (CZ); Rodney T. Cox, North Plains, OR (US)

(72) Inventors: Joseph J. Cox, Modiin (IL); Isaiah W. Cox, London (GB); Jan Vana, Prague (CZ); Rodney T. Cox, North Plains, OR (US)

(21) Appl. No.: 14/341,765

(22) Filed: Jul. 26, 2014

(30) Foreign Application Priority Data
Mar. 18, 2014 (US) PCT/US14/31111

(51) Int. Cl. B64C 25/40; B64D 31/00

(52) U.S. Cl. CPC B64C 25/405; B64D 31/00

(57) ABSTRACT

A system is provided for maximizing efficient ground travel in wide-body and other aircraft equipped with onboard non-engine drive means for autonomous ground travel. Selective operation of the non-engine drive means and selective operation of the aircraft's engines are integrated to power aircraft movement when different ground travel speeds are required between landing and takeoff, optimizing savings and maximizing the cost/benefit ratio for equipping the aircraft with a non-engine drive means. The non-engine drive means may be designed to move a wide-body aircraft at low speeds required for ground maneuvers in a ramp area to move the aircraft at speeds typically used for pushback, initial forward roll, all start-stop situations, and other low speed ground travel. One or more of the aircraft's engines may be operated to move the aircraft at higher taxi speeds.

### PRIORITY CLAIM

This application claims priority from International Patent Application No. PCT/US2014/031111, filed 18 Mar. 2014, the disclosure of which is fully incorporated herein by reference.

### TECHNICAL FIELD

The present invention relates generally to the movement of aircraft taxiing on the ground between landing and takeoff and at other times requiring aircraft ground travel and specifically to a ground movement system and method designed to maximize efficient ground movement and optimize savings possible when wide-body aircraft are equipped with onboard non-engine drive means controllable in conjunction with operation of the aircraft's engines to move the aircraft during ground travel.

### BACKGROUND OF THE INVENTION

Moving aircraft efficiently on the ground between landing and takeoff has received much attention recently. Approximately 5% of an aircraft's total fuel usage is consumed during ground travel. Reducing the amount of fuel needed by an aircraft during ground movement is accompanied by significant benefits that include not only reduced fuel costs resulting from reduced fuel consumption, but reduced carbon emissions and noise. Currently, aircraft are moved between runways and gates or other airport parking locations by operation of one or more of an aircraft's engines and/or by attachment to external tow vehicles that does not require aircraft engine operation. These methods of ground travel are not particularly efficient, but are used by virtually all aircraft.

Alternative methods of moving aircraft on the ground without operation of aircraft engines to reduce fuel usage and increase efficiency have been proposed. These methods include, for example, automated tug vehicles that attach externally to an aircraft to guide its travel and onboard drive means that power one or more landing gear wheels to move an aircraft during ground travel. Unmanned aircraft transfer systems and automated towing vehicles capable of moving aircraft on the ground are described, respectively, in U.S. Pat. No. 7,975,959 to Perry et al and U.S. Pat. No. 6,305,484 by LeBlanc. Using a self-propelled undercarriage wheel to move an aircraft autonomously along taxiways is proposed by Cox et al in U.S. Pat. No. 7,891,609, owned in common with the present application.

While the foregoing systems and methods for moving aircraft during ground travel represent ways in which operating efficiency and fuel reduction may be achieved, the operation of such systems and methods during all ground travel may not be optimally efficient for all aircraft. Wide-body aircraft, for example, which often must be maneuvered into and out of ramp areas somewhat differently than narrow body or smaller aircraft may require a different approach to the control of ground travel.

Aircraft are currently parked at airport terminals and gates with the nose end of the aircraft pointed toward the terminal or gate. This parking orientation is used because aircraft presently use engines to power travel from a landing location to a parking location within an airport ramp area. When an aircraft's engines are operating, jet blast and engine ingestion can compromise the safety of persons and ground equipment within the engine hazard area, especially near a gate or terminal where there are likely to be more persons and equipment, as well as other aircraft. When all aircraft are parked in the same nose-in orientation, the danger areas where engine ingestion or jet blast could occur when aircraft engines are operating are at least somewhat predictable. Other aircraft parking orientations besides the currently used nose-in orientation, however, could allow more aircraft to park at gates, stands, or other parking areas near an airport terminal. For example, parking an aircraft with the longest axis of the aircraft body parallel to the terminal or at an angle relative to the terminal other than the perpendicular orientation currently used may actually allow more efficient use of terminal parking space resources, for wide-body and other aircraft. The present need to use aircraft engines to drive aircraft within ramp areas to terminal gates and other parking areas, however, prohibits the use of these aircraft parking orientations because of the risks of jet blast and engine ingestion dangers associated with aircraft engine operation.

A need exists for a system and method for optimizing aircraft ground travel, particularly for wide-body aircraft equipped with onboard non-engine drive means for autonomous ground movement, that enables such aircraft to travel on the ground between landing and takeoff and park at or near a terminal with significantly greater efficiency than is now possible. A need also exists for a system and method that integrates operation of aircraft engines and non-engine drive means to power ground movement and to enable maximally efficient low speed ground movement of wide-body and other aircraft into and out of airport ramp areas and parking locations, as well as maximally efficient higher speed ground travel between landing and takeoff.

### SUMMARY OF THE INVENTION

It is a primary object of the present invention to provide a system and method for optimizing ground travel of wide-body aircraft equipped with onboard non-engine drive means for autonomous ground movement that enables these aircraft to travel on the ground between landing and takeoff and at other times and to park at or near a terminal with significantly greater efficiency than is now possible.

It is another object of the present invention to provide a method that integrates operation of aircraft engines and non-engine drive means to enable maximally efficient low speed ground movement of wide-body and other aircraft into and out of airport ramp areas and parking locations, as well as maximally efficient higher speed ground travel on runways between landing and takeoff.

It is another object of the present invention to provide a system and method for optimizing ground travel of wide-body aircraft equipped with onboard non-engine drive means for autonomous ground movement, wherein the onboard non-engine drive means is designed to move the aircraft at speeds specifically selected for optimum wide-body aircraft ground travel at pushback, initial forward roll, start-stop travel, and other situations requiring an aircraft speed different from taxi speed for optimally efficient ground movement.

It is an additional object of the present invention to provide a system and method for optimizing ground movement in wide-body aircraft equipped with onboard non-engine drive means for autonomous ground travel that enables a wide-body aircraft to maneuver in only a forward direction into and out of an airport ramp area.

It is a further object of the present invention to provide a method for optimizing savings when a wide-body aircraft is equipped with onboard non-engine drive means for autonomous ground movement and aircraft ground travel is controlled by the non-engine drive means at designated selected aircraft ground travel speeds and maneuvers and by operation of one or more of the aircraft's engines at other designated selected ground travel speeds and maneuvers.

It is yet an additional object of the present invention to provide a system for optimizing efficiency during ground travel of wide-body and other aircraft equipped with lightweight onboard non-engine drive means controllable by a simplified cockpit control system that integrates operation of the onboard non-engine drive means with operation of aircraft engines during taxi to maximize the efficiency of aircraft ground travel.

It is yet a further object of the present invention to provide an optimally efficient ground movement system and method for aircraft equipped with onboard non-engine drive means that integrates operation of the non-engine drive means to drive the aircraft at defined selected speeds and ground conditions with operation of one or more aircraft engines at defined selected speeds and ground conditions to enable the aircraft to optimize savings possible with non-engine drive means ground travel while enabling maximally efficient aircraft ground movement.

In accordance with the aforesaid objects, a system and method for optimizing efficient ground travel in wide-body and other aircraft equipped with onboard non-engine drive means for autonomous ground travel are provided. The present system and method optimize efficiency of aircraft ground travel and ground maneuvers by integrating the selective operation of the non-engine drive means with the selective operation of one or more of the aircraft's engines, thereby maximizing the cost/benefit ratio for equipping the aircraft with a non-engine drive means. The non-engine drive means may be designed to move a wide-body or other aircraft in only a forward direction as required to pull into a terminal parking space, park an aircraft parallel to the terminal, and proceed to a takeoff runway. A non-engine drive means and cockpit controls that operate and control the non-engine drive means may also be designed to move a wide-body or other aircraft only at the relatively lower speeds typically used for pushback, initial forward roll, all start-stop situations, and other low speed ground travel, or to move only in a forward direction to park at a terminal as described above. One or more of the non-engine drive means-equipped aircraft's engines may be operated to move the aircraft at taxi or other higher speeds when it is more efficient to power ground travel with the aircraft's engines.

Other objects and advantages will be apparent from the following description, claims, and drawings.

### BRIEF DESCRIPTION OF THE DRAWINGS

FIG. 1 illustrates a wide-body aircraft equipped with an onboard non-engine drive means for autonomous ground movement and the integrated ground movement system of the present invention powered by at least one of the aircraft's engines to move at taxi speed on a runway after landing and prior to entering an airport ramp area to park at an airport terminal; and

FIG. 2 illustrates a wide-body aircraft equipped with onboard non-engine drive means entering, parking, and leaving an airport ramp and terminal area at ramp maneuvering speed while moving in only a forward travel direction, wherein ground movement is controlled solely by operation of the non-engine drive means.

### DESCRIPTION OF THE INVENTION

Increasing the efficiency with which aircraft can move on the ground between landing, airport gate operations, and takeoff enables airlines to move aircraft, passengers, and cargo as quickly and safely as possible. Inefficiencies and delays can have both local and widespread undesirable effects for both passengers and airlines. When wide-body aircraft are delayed as a result of inefficient ground movement, larger numbers of passengers are affected than when other aircraft are delayed. Currently, aircraft are moved on the ground by the operation of one or more of the aircraft's engines, which may effectively move aircraft on runways or taxiways at the taxi speeds set by airports. Aircraft currently also travel into a terminal gate or other parking location in a ramp area near an airport terminal with engines operating. Jet blast and engine ingestion hazards associated with operating aircraft engines near an airport terminal have a significant effect on the safety and efficiency with which gate operations can be conducted. When aircraft are equipped with non-engine drive means for autonomous ground movement, operation of the aircraft's engines is not required to move the aircraft on the ground. Movement of these aircraft within a ramp or gate area is not accompanied by jet blast or engine ingestion hazards. Although all aircraft ground movement in aircraft equipped with non-engine drive means could be powered by the non-engine drive means, there are types of aircraft and ground travel situations in which integrating operation of the aircraft engines with operation of the non-engine drive means can optimize not only efficient aircraft ground travel, but also the savings that accompany non-engine drive means-powered aircraft ground movement.

The present system, although intended primarily for wide-body aircraft, can also be effectively employed on narrow body and other aircraft. Wide-body aircraft, like the Airbus 380 and the Boeing 747 to 787 series aircraft, typically have two aisles in the passenger compartments and are capable of carrying 200 to 850 passengers, with up to 11 passengers in a row. These aircraft have a fuselage diameter in the range of 5 to 6 meters (16-20 feet). In contrast, narrow body aircraft, which are the majority of aircraft flown today, have a single aisle passenger compartment that seats 2 to 6 people in a row and a fuselage diameter in the range of 3 to 4 meters (10-13 feet). Maneuvering a wide-body aircraft on the ground, particularly within an airport ramp area and near a terminal must take into account not only the substantially larger size of the aircraft compared to narrow body aircraft, but also the significantly larger numbers of passengers that must be accommodated at arrival and departure. Their size and weight also require more power to move wide-body aircraft as they travel on the ground between landing and takeoff than smaller aircraft.

In accordance with the present ground movement system for wide-body aircraft, aircraft are equipped with one or more onboard non-engine drive means capable of moving the aircraft autonomously on the ground. The one or more non-engine drive means are designed to one power one or more landing gear wheels to move the aircraft autonomously on the ground without reliance on aircraft main engines or tow vehicles. The preferred location for drive means is within each wheel of the aircraft nose landing gear wheels. Providing drive means on one or more main landing gear wheels may also be suitable in some aircraft. A preferred drive means is an electric motor assembly, preferably powered by the aircraft auxiliary power unit, that is capable of operating at the torque and speed required to move a wide-body aircraft landing gear wheel and, therefore, a wide-body aircraft on the ground at the speeds described herein. An example of one of a number of suitable types of drive means useful in an aircraft landing gear drive wheel that could be used effectively in the present gate traffic management system is an inside-out electric motor in which the rotor can be internal to or external to the stator, such as that shown and described in U.S. Patent Application Publication No. 2006/0273686, the disclosure of which is incorporated herein by reference. A range of motor designs capable of high torque operation across a desired speed range that can move an aircraft wheel and function as described herein to move an aircraft autonomously may also be suitable drive means useful in the present invention. A high phase order electric motor of the kind described in, for example, U.S. Pat. Nos. 6,657,334; 6,838,791; 7,116,019; and 7,469,858, the disclosures of the aforementioned patents being incorporated herein by reference, can be effectively used as a drive means. One particularly suitable drive means is a high phase order induction motor with a top tangential speed of about 15,000 linear feet per minute and a maximum rotor speed of about 7200 rpm, although drive means capable of a wide range of such speeds could be used with the present drive wheel drive system. Other drive means, including hydraulic and/or pneumatic drive means, are also contemplated to be useful as landing gear wheel non-engine drive means.

It is preferred that the non-engine drive means selected for use in the present ground movement system be designed to achieve top speeds of and drive an aircraft at about 4 to 8 miles per hour (mph), or even at 4 to 6 mph. This speed range is an optimum range for specific phases of aircraft ground travel, including without limitation, pushback, the initial forward roll, and all start-stop or stop-and-go situations. The non-engine drive means could also be designed to move an aircraft at slightly higher speeds. Aircraft engines could also be enabled for stop-and-go situations, if this produces more efficient ground travel in a wide-body aircraft in specific situations. Since aircraft taxi speed is typically about 28 to 30 mph at most airports, all wide-body aircraft ground movement could not be powered by a non-engine drive means designed to have a top speed of 4 to 8 mph. Consequently, in accordance with the present invention, aircraft ground movement at the higher taxi speeds may be powered by thrust from at least one aircraft engines, while ground movement at the slower ramp speeds may be powered by a non-engine drive means. In the event of high runway traffic, engines may be shut down and the non-engine drive means activated to control ground travel more efficiently.

The present system integrates engine control with non-engine drive means control of aircraft ground movement so that neither the aircraft engines nor the non-engine drive means is operating during all aircraft ground travel. The integrated system described herein optimizes the savings possible with the operation of non-engine drive means and maximizes the relationship between cost and benefit of the non-engine drive means. Control of ground movement of a wide-body aircraft by the integrated operation of the aircraft's engines to move an aircraft during high speed taxi and a non-engine drive means capable of driving the aircraft during selected ground movement events at the lower speeds will be described in more detail in the EXAMPLE below.

A non-engine drive means designed to drive a wide-body or other aircraft at speeds in the range of 4 to 8 mph primarily within a ramp area may be correspondingly smaller and lighter than a non-engine drive means designed to drive an aircraft at typical high taxi speeds of up to 30 mph after touchdown and prior to takeoff. Such a smaller and lighter non-engine drive means, in addition to adding less weight when installed on a landing gear wheel, may significantly reduce any fuel uncertainty, producing a resulting reduction in aircraft flight weight attributable to fuel. The non-engine drive means would not be required to work 100% of the time during ground movement, but the cost/benefit ratio of moving an aircraft with non-engine drive means would be maximized. It is estimated that a non-engine drive means designed to move an aircraft at the low speeds and during the ground movement periods described can provide about 80% of the benefit of a non-engine drive means operating full time to power wide-body aircraft ground movement.

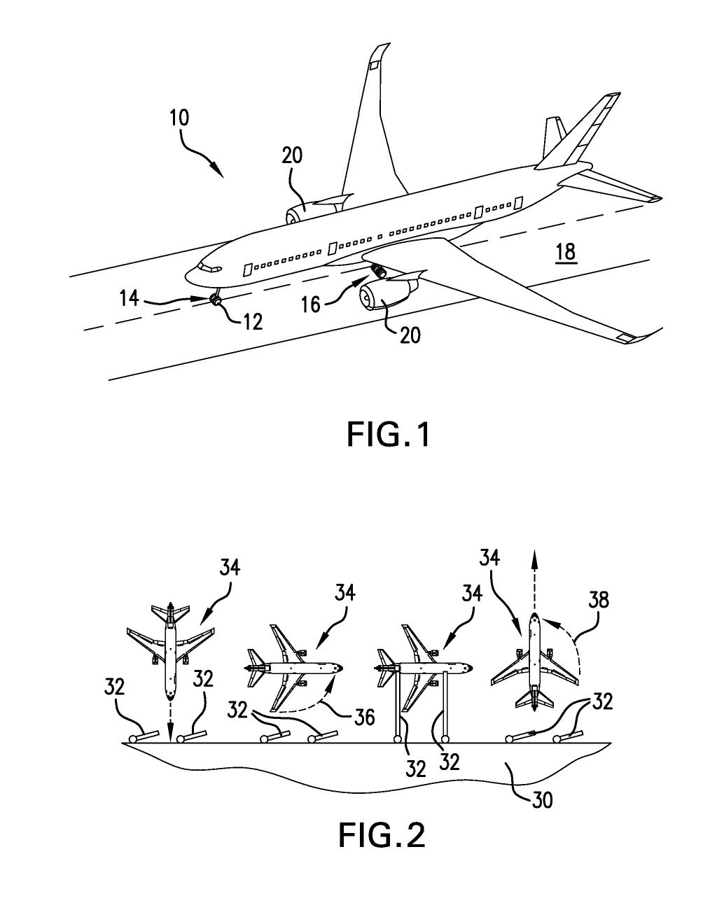

Referring to the drawings, FIG. 1 illustrates a wide-body aircraft 10 equipped with one or more onboard non-engine drive means 12, as described above, shown mounted in the aircraft's nose landing gear wheels 14. One or more non-engine drive means may, alternatively or in addition, be mounted in one or more of the aircraft's main landing gear wheels 16. The aircraft 10 of FIG. 1 is shown taxiing on a runway 18. In accordance with present wide-body aircraft ground movement system, one or more of the aircraft's main engines 20, rather than the non-engine drive means 12, would be operating to power the aircraft's ground travel during taxi at taxi speeds on a runway as shown.

As noted above, movement of wide-body aircraft into and out of ramp areas and terminal gates can present challenges, in large part because of the size of these aircraft and the large numbers of passengers to be accommodated at the terminal. A system for moving aircraft into and out of gates and parking stands so that passengers can exit and enter the aircraft with greater efficiency than was possible is described in commonly owned co-pending International Patent Application No. PCT/US13/72508, filed 29 Nov. 2013, and entitled Airport Terminal Aircraft Gate Traffic Management System and Method, the disclosure of which is fully incorporated herein by reference. The system described in the aforementioned patent application directs aircraft equipped with onboard non-engine drive means for autonomous ground movement into and out of gates, parking stands, and other parking locations by using the non-engine drive means to move the aircraft in only a forward direction to park in an orientation parallel to an airport terminal.

Movement of wide-body aircraft in only a forward direction with a non-engine drive means increases the safety and efficiency of gate operations by eliminating jet blast and engine ingestion hazards associated with operating aircraft engines near an airport terminal, as well as the numbers of ground personnel and vehicles needed to support engines-on taxi within the ramp area. Aircraft taxi with non-engine drive means may be controlled primarily by aircraft pilots, who can direct aircraft maneuvers into and out of gate and stand parking. The efficiency of passenger movement into and out of a parked aircraft is maximized by the ability to use all aircraft passenger doors for deplaning and boarding, simultaneously, if desired. Flexibly movable jet bridges may be spaced and extended to connect with doors on a parked wide-body aircraft and then retracted to maximize space at a parking location so a wide-body aircraft has at least the minimum clearance required to turn and leave the parking location at departure. Servicing of aircraft can begin virtually immediately upon arrival at a parking space and can be made more efficient by providing fixed dedicated services equipment designed to connect directly to aircraft at the parking location.

FIG. 2 illustrates forward movement of a wide-body aircraft into and out of an airport terminal gate. An aircraft terminal 30 has a number of flexibly movable jet bridges 32. The jet bridges 32 are shown to be rotatably attached to the terminal 30 to rotate into and out of connection with aircraft doors. Other terminal and/or ground attachment structures and methods may also be used. The movement of a wide-body aircraft 34 equipped with non-engine drive means as described above is controlled by the non-engine drive means as the aircraft approaches the terminal in a nose-in position and then rotates or turns 90° along a path shown by arrow 36 to park with the longest axis of the aircraft parallel to the terminal. The flexibly movable jet bridges 32 attached to the terminal may be spaced to permit connections to two wide-body aircraft doors. The jet bridges 32 may remain in the retracted position close to the terminal 30 shown to provide a maximum amount of space for a wide-body aircraft while it is maneuvering at the gate to facilitate parking of the aircraft parallel to the terminal. Upon arrival at the terminal 30, the aircraft 34 turns 90° as described and is moved by the non-engine drive means to an assigned gate parking space or stand. Once the aircraft has parked, two flexible movable jet bridges 32 may be extended to connect with the aircraft front and rear doors. Although it is not as efficient for moving passengers out of and into the aircraft, if necessary, only one jet bridge may be connected to the aircraft at airport terminals that do not have the preferred optimum arrangement of jet bridges.

When departing passengers have boarded and the aircraft 34 is ready for departure, the jet bridges 32 may be moved away from the aircraft to clear the parking space. The aircraft pilot may activate and control the non-engine drive means to move the aircraft 34 in a forward direction and turn it 90° along the path shown by arrow 38 so that the aircraft nose is pointed away from the terminal 30. The pilot may then drive the aircraft in a forward direction away from the terminal to a takeoff runway, where the at least one of the aircraft engines may be activated to move the aircraft during taxi.

All of the aircraft movements shown in FIG. 2 are in a forward direction. This provides an aircraft pilot with the ability to keep the aircraft travel area in view while the aircraft is turning and moving into or out of the terminal parking area. Driving the aircraft in reverse, while not necessary with the present wide-body ground movement system, can also be done by controlling the non-engine drive means to move the aircraft in reverse.

When the flexibly movable jet bridges 32 are connected to both front and rear doors of the aircraft, passengers, crew, cleaning and other service personnel can be moved into and out of the aircraft using both doors while it is parked at the gate, increasing the efficiency and decreasing the time for turning the aircraft around. Since aircraft engines are not used within the ramp area in the present wide-body aircraft ground movement system, ground services vehicles and personnel can approach the aircraft as soon as it is parked at the terminal, and baggage and cargo transfer, fueling, catering, and other services can be commenced without having to wait until the engines are completely shut down to avoid the adverse effects associated with operating aircraft engines.

The present wide-body aircraft ground movement system has been discussed in connection with the use of passenger loading bridges or jet bridges at terminal gates or stands to transfer passengers between an airport terminal and the aircraft. In some airports, terminal gates do not provide sufficient space between jet bridges or parking stands to accommodate wide-body aircraft. In addition, airports in many countries do not have terminal buildings with jet bridges. In these airports, when an aircraft arrives at a gate, either the aircraft's stairs are lowered or ground personnel bring portable stairs to aircraft that do not have integral stairs. Aircraft equipped with non-engine drive means to move the aircraft autonomously on the ground are able to move closer to a terminal and to lower their stairs or have portable stairs brought to the aircraft as soon as the aircraft has come to a top without waiting for the aircraft's engines to be turned off and the turbines to stop moving. The doors can be opened as soon as the stairs are in place, and passengers can leave the aircraft immediately. Since aircraft have two front and two rear doors, stairs could be provided for all four doors. When all four doors are used by the passengers exiting the aircraft, it is possible to empty it very quickly. Deplaning and boarding may be conducted simultaneously, with deplaning passengers leaving by one set of doors and boarding passengers by another set. Aircraft that use stairs instead of jet bridges may park closer to gates and terminal services, thus minimizing the distance passengers and crew need to walk to the gate or terminal building.

Operation of the present ground movement system for a wide- body aircraft equipped with a non-engine drive means is described in the following EXAMPLE.

### EXAMPLE

A wide-body aircraft, such as, for example, a Boeing 767 or an Airbus 380, is equipped with a non-engine drive means, preferably one of the electric motors described above, designed to drive the aircraft at a top speed of about 4 to 8 mph. A non-engine drive means may be mounted in each wheel on the nose landing gear of the aircraft. The wide-body aircraft lands at an airport, the aircraft engines are used to move the aircraft at airport taxi speed from a touchdown location along a taxi path toward the airport ramp area where the aircraft's arrival location is located. If the runway traffic is heavy or if the aircraft must come to a stop during taxi, such as, for example, to wait for another aircraft at a crossing runway, the aircraft engines are shut off, and the non-engine drive means is activated to move the aircraft when it starts to move forward. The aircraft then travels at a speed within the 4 to 8 mph speed range of the non-engine drive means to its arrival location.

Prior to the aircraft's arrival at the ramp area, its engines are shut down, and ground movements in this usually congested area are controlled entirely by operation of the non-engine drive means. The aircraft is driven by the non-engine drive means in only a forward direction to its designated parking destination and makes a 90° turn before coming to a complete stop at a parking location so that the longest axis of the aircraft is parallel to the terminal, as shown and described in connection with FIG. 2. Jet bridges or stairs are provided, and passengers exit the aircraft through front and rear doors. The aircraft is prepared to receive passengers for the aircraft's departing flight as soon as the aircraft is empty, and these departing passengers and their baggage are loaded on the aircraft through both front and rear doors. Jet bridges or stairs are moved away from the aircraft.

The aircraft is cleared for departure, the pilot activates the non-engine drive means, and the aircraft is driven in an initial forward roll to then make a 90° turn away from the terminal. The pilot continues to control the non-engine drive means to drive the aircraft at a safe ground travel speed for the ramp conditions out of the ramp area and onto a takeoff runway. On the takeoff runway, the non-engine drive means is deactivated, and one or more of the aircraft's engines are started. The aircraft is driven on the ground at taxi speed by power from the engines as to taxi to a takeoff location.

Although a wide-body aircraft parked parallel to an airport terminal may permit more efficient unloading and loading of passengers, baggage, and cargo and servicing, it is also contemplated that a wide-body aircraft equipped with a non-engine drive means may be driven into a ramp area, as described above, to park at a terminal in a traditional nose-in position. In this case, when the aircraft has been cleared for departure, the pilot will activate the non-engine drive means to move the aircraft in a reverse direction to a location where the aircraft has cleared the gate area and can then be moved in a forward direction by the non-engine drive means out of the ramp area to a takeoff runway where the non-engine drive means will be deactivated and the aircraft engines turned on to move the aircraft at taxi speed to a takeoff location.

Cockpit controls for a part-time non-engine drive means as described above may be simplified, compared to what may be needed for a full-time non-engine drive means. Such cockpit controls may include, for example without limitation, at least a non-engine drive means power off/on switch, a forward drive knob or button, a reverse button (preferably guarded to prevent inadvertent activation), and a warning indicator. A warning indicator could communicate, for example, that the non-engine drive means is not operating properly or that the drive means is operating when it should not be, so that the pilot can manually inactivate the non-engine drive means, if necessary.

As noted above, the preferred use of the present integrated ground movement system will be for wide-body aircraft that may have different ground movement power requirements than other, smaller aircraft. This integrated ground movement system may also be effectively used to power and control ground movement in narrow body and other smaller aircraft. A large portion of the benefit associated with non-engine drive means-controlled aircraft taxi can be realized with a simpler system that works part time with the aircraft engines to optimize the savings possible when aircraft are equipped with non-engine drive means that may be activated for autonomous ground movement. The present invention makes it possible to maximize the overall aircraft operational benefits that are realized when an aircraft equipped with an onboard non-engine drive means and at least one engine is moved on the ground as described above. The onboard non-engine drive means and the aircraft's engine may be selectively operated to move the aircraft on the ground. Consequently, the costs and benefits of operating the non-engine drive means to move the aircraft on the ground and the costs and benefits of operating the aircraft's engine to move the aircraft on the ground are balanced to maximize overall aircraft operational benefits.

While the present invention has been described with respect to preferred embodiments, this is not intended to be limiting, and other arrangements and structures that perform the required functions are contemplated to be within the scope of the present invention.

### INDUSTRIAL APPLICABILITY

The ground movement system for aircraft equipped with non-engine drive means for wide-body and other aircraft that integrates operation of aircraft engines and operation of non-engine drive means to power ground movement as described herein will find its primary applicability when it is desired to move aircraft between landing and takeoff at an airport with maximum efficiency while optimizing savings possible with the non-engine drive means.

1. A system for moving aircraft on the ground, comprising
a. an aircraft with one or more aircraft landing gear wheels equipped with one or more non-engine drive means controllable to move said aircraft only at a first speed during a selected first aircraft ground travel period, and at least one engine operable to move said aircraft at a second speed during a selected second aircraft ground travel period; and
b. ground movement control means activatable and controllable to control operation of said non-engine drive means to move said aircraft at said first speed and to control operation of said at least one engine to move said aircraft at said second speed.

2. The system of claim 1, wherein said aircraft comprises a wide-body aircraft and said first speed is lower than said second speed.

3. The system of claim 2, wherein said first speed is within the range of 4 to 8 miles per hour and said second speed is in the range of about 28 to 30 miles per hour.

4. The system of claim 2, wherein said selected first aircraft ground travel period comprises one or all of pushback, initial forward roll, and start-stop situations.

5. The system of claim 2, wherein said selected second aircraft ground travel period comprises taxi on a runway.

6. The system of claim 1, wherein said ground movement control means comprise cockpit controls adapted to integrate control of said non-engine drive means to move said aircraft during said first ground travel period with control of said at least one aircraft engine to move said aircraft during said second ground travel period.

7. A method comprising controlling ground movement in an aircraft with at least one engine and one or more landing gear wheels equipped with non-engine drive means for autonomous ground travel by integrating operation of said at least one engine and said non-engine drive means to move said aircraft with optimal efficiency during ground travel, wherein operation of said at least one engine is controlled to move said aircraft during selected first ground travel situations and at speeds when said engine most efficiently powers aircraft ground movement, and said non-engine drive means is controlled to move said aircraft during selected second ground travel situations and at speeds to optimize fuel and time savings from operation of said non-engine drive means to drive said aircraft.

8. The method of claim 7, wherein said aircraft is a wide-body aircraft, said first ground travel situations and speeds comprise aircraft taxi at an aircraft ground travel speed in the range of about 28 to 30 miles per hour, and said second ground travel situations and speeds comprise one or all of pushback, initial forward roll, and start-stop situations at an aircraft ground travel speed in the range of 4 to 8 miles per hour.

9. The method of claim 7, further comprising providing pilot-operated control means in a cockpit of said aircraft whereby operation of said at least one engine is controlled to optimize ground movement of said aircraft during taxi on a taxi runway and operation of said non-engine drive means is controlled to optimize ground movement of said aircraft autonomously without operation of said at least one engine into and out of an airport ramp area.

10. The method of claim 9, wherein operation of said non-engine drive means is controlled to move said aircraft in only a forward direction into and out of said ramp area.

11. The method of claim 10, wherein operation of said non-engine drive means is controlled to move said aircraft in said forward direction to a parking location to park with a longest axis of said aircraft parallel to an airport terminal so that a maximum number of doors on said aircraft are used to enable passengers to exit and enter said aircraft through said maximum number of doors.

12. A method comprising integrating operation of aircraft engines and aircraft non-engine drive means to optimize efficiency of aircraft ground travel between landing on and takeoff from a runway, wherein at least one of said aircraft engines is operated to power ground travel at taxi speed from a landing location to a ramp area and is then shut down; said non-engine drive means is operated to move said aircraft at a speed significantly slower than said taxi speed from said runway and within said ramp area to a parking location and is then deactivated while said aircraft is unloaded and loaded; said non-engine drive means is operated to move said aircraft at said speed significantly slower than said taxi speed from said parking location to said runway and is then deactivated; and said at least one engine is operated to move said aircraft at said taxi speed on said runway for takeoff.

13. The method of claim 12, wherein said taxi speed is about 28 to 30 miles per hour and said speed significantly slower than taxi speed is about 4 to 8 miles per hour.

14. The method of claim 12, wherein said aircraft is moved within said ramp area in only a forward direction, and said aircraft is parked at said parking location in an orientation with a longest axis of said aircraft parallel to an airport terminal.

15. The method of claim 12, wherein said non-engine drive means is operated to move said aircraft during pushback, during an initial forward roll, and during all ground travel start-stop situations.

16. A method comprising maximizing overall aircraft operational benefits realized by moving an aircraft equipped with an onboard non-engine drive means and at least one onboard engine on the ground, wherein the onboard non-engine drive means and the at least one onboard engine are selectively operated to optimize movement of the aircraft on the ground so that costs and benefits of operating the non-engine drive means to move the aircraft on the ground and costs and benefits of operating the at least one onboard engine to move the aircraft on the ground are balanced to maximize said overall aircraft operational benefits.
